(19) United States
(12) Patent Application Publication
(10) Pub. No.: US 2005/0051184 A1
(43) Pub. Date: Mar. 10, 2005

(54) Printing mechanism for a machine of the tobacco processing industry

(75) Inventors: Manfred Dombek, Dassendorf (DE); Helmut Voss, Lockstedt (DE)

Correspondence Address: GREENBLUM & BERNSTEIN, P.L.C., 1950 ROLAND CLARKE PLACE, RESTON, VA, 20191, US

(73) Assignee: Hauni Maschinenbau AG, Hamburg (DE)

(21) Appl. No.: 10/926,074

(22) Filed: Aug. 26, 2004

(30) Foreign Application Priority Data
Sep. 8, 2003 (EP) 03 020 292.3

(51) Int. Cl. B41J 2/175

(52) U.S. Cl. 131/284

(57) ABSTRACT

Method and printing mechanism for applying print marks on an article. The method includes conveying a tobacco processing industry article along a transport direction at a predetermined conveying speed, and applying the print mark to the tobacco processing industry article via at least one ink jet printer cartridge. The instant abstract is neither intended to define the invention disclosed in this specification nor intended to limit the scope of the invention in any way.

### CROSS-REFERENCE TO RELATED APPLICATIONS

The present application claims priority under 35 U.S.C. §119 of European Patent Application No. 03 020 292.3, filed on Sep. 8, 2003, the disclosure of which is expressly incorporated by reference herein in its entirety.

### BACKGROUND OF THE INVENTION

1. Field of the Invention

The instant invention relates to a method and a printing mechanism for applying print marks on an article of the tobacco processing industry conveyed along a transport direction at a predetermined conveying speed, in particular, on a wrapping strip, and preferably, a cigarette paper strip. Furthermore, the present invention relates to a method of printing with of at least one ink jet printer cartridge, and to a machine of the tobacco processing industry, in particular, an endless rod maker (rod-making machine) or filter tipping machine.

2. Discussion of Background Information

Printing mechanisms for applying print marks on a wrapping strip of the tobacco processing industry are known from prior art. For example, an imprint is applied onto cigarette paper strips with a printing roller in an endless rod maker. Rod-shaped articles such as cigarettes, cigarillos, cigars, or filter rods or the like are produced in the rod maker by the rod method. The tobacco rods are wrapped by the wrapping strip in the endless rod maker, whereby the wrapping strips used feature print marks or print images that can be, e.g., cigarette trademarks, the names of manufacturers, or other information.

Smoking articles in the sense according to the invention are to be understood to mean cigarettes with and without a filter as well as all other rod-shaped smoking articles the wrapping strip of which is printed, whereby the imprint appearing on the article primarily denotes the trademark. Such an imprint or stamp is a striking quality feature of such articles and requires particular attention to be paid to the components and production conditions required for its production, such as the type and condition of the ink used and its feed, transfer, distribution, up to the application on the wrapping strip.

According to the prior art, the printing mechanisms built into the rod makers are composed of a roller arrangement, whereby the material web to be imprinted is guided between the rollers. A so-called “printing roller” is provided for applying the print marks or print images, which roller is synchronized with the continuously moved material web. As a rule, the printing roller is in contact with a counter-pressure roller, such that the wrapping strip is guided between the printing roller and the counter-pressure roller.

However, the printing mechanisms have the disadvantage that, as a consequence of the rotation of the printing roller and a higher conveying speed of the wrapping strip, the quality of the imprint is reduced or may be impossible, so that the production of endless rods with an imprint on the wrapping strip is severely restricted at higher machine speeds.

Moreover, in International Publication No. WO02/078959, a print head is described that is provided with piezoelectric elements on a membrane in the vicinity of the nozzles of the print head. This special print head is used in order to apply stampings onto cigarette cartons, wrappings of cigarette packs.

Furthermore in U.S. Pat. No. 6,173,551 and International Publication No. WO99/51498 ink jet coders in packaging machines of the tobacco processing industry are disclosed. A print head made by Videojet System International, Illinois, U.S.A. is used as an ink jet coder. Marks made of individual ink drops are hereby printed onto a material strip. The markings are sprayed on in a contactless manner during a feed movement of the material strip, whereby a piezoelectric spray nozzle quartz that surrounds the spray nozzle ink chamber is excited. The vibrations of the nozzle quartz divide the nozzle stream into droplets of ink. In order to apply a mark onto a material strip, the individual drops of ink are deflected by a deflector plate. The degree of the deflection is a function of the height of the negative charge on the drop of ink. Overall this technology is very expensive.

### SUMMARY OF THE INVENTION

In view of this prior art, the present invention provides for printing of print images on articles of the tobacco processing industry, in particular, wrapping strips or rod-shaped articles, at high conveying speeds of the articles without great expense. In this way, it is to be possible to apply the print mark perfectly at high conveying speeds of the article. Furthermore, the invention enables a rapid change of the print image and reduction of the otherwise customary expense and effort of changing over and cleaning.

Accordingly, the instant invention provides a method for applying print marks on an article of the tobacco processing industry conveyed along a transport direction at a predetermined conveying speed, in particular a wrapping strip, preferably a cigarette paper strip, by means of a printing mechanism, in that the print marks are applied by at least one ink jet printer cartridge of the printing mechanism.

The invention is based on the concept of using commercially available standard printer cartridges for ink jet printers used in the usual office sphere. Within the scope of the invention, it is likewise possible to apply imprints onto blanks or other moved materials of the packaging industry by a printing mechanism that has at least one ink jet printer cartridge. The mature and proven technology of office ink jet printers is applied by the use of standardized ink jet printer cartridges to machines of the tobacco processing industry or the packaging industry. Within the scope of the invention, the ink jet printer cartridges used are cartridges that have a container or a chamber for the ink, whereby the container, depending on the application, can feature a print head. If a print head is present in a printing mechanism, the cartridge does not feature a print head.

In ink jet printing a print mark is applied in a contactless manner onto the material strip guided past the printer cartridge. In addition, colored imprints are also possible, since several chambers with different colors can be present in one cartridge. By using a color cartridge with several chambers, colored imprints can thus be realized. As a rule, within the scope of the invention exclusively water-soluble inks are used that are also suitable for foodstuffs. It is further possible to apply inks that are invisible to the human eye onto the cigarette paper or the material strip, so that safety markings or position marks are applied on the material strip.

Moreover, according to the invention, the change-over times, e.g., during a garniture change and the cleaning expense for the printing mechanism are reduced. Furthermore, a rapid and simple change of the print image can be carried out by these means during a garniture change.

Advantageously, the printing mechanism and/or the at least one ink jet printer cartridge are mounted in a stationary manner, so that the article to be imprinted is transported past the stationary cartridge. This guarantees a reliable application of an imprint. The overall result is a secure handling of the ink jet printer cartridge used.

An increase in the printing speed is achieved in that a print mark is applied by means of several ink jet printer cartridges. Several ink jet printer cartridges are used to produce a print mark so that a marking is applied onto a cigarette paper strip simultaneously.

In a further development it is suggested that several ink jet printer cartridges be arranged in and/or transverse to the conveying direction of the article. This causes the working area for printing a print mark to be enlarged. In addition a rapid adjustment of the printing mechanism to articles of different widths that are to be imprinted is achieved.

In particular, the ink jet printer cartridges are arranged in cascade form, so that it is possible for one ink jet printer cartridge respectively to imprint a specific area of the conveyed article. Then, another area of the print mark is imprinted by a subsequent second ink jet printer cartridge. The quality and/or density of the print is improved overall by these devices. Furthermore, it is possible by these devices to increase the conveying speed of the article distinctly.

It is particularly advantageous if the ink jet printer cartridges are controlled by a control device, in particular, a computer unit. By using a software-oriented control, it is possible for several ink jet print heads or cartridges to be triggered in such a way that a print mark is produced by several ink jet printer cartridges. Moreover, this has the advantage that during a garniture change or trademark change on an endless rod maker, the print mark to be applied on the cigarette paper can be converted rapidly. In this case it is no longer necessary to exchange printing stamps or the like manually.

In addition it is favorable if the print marks are dried in a drying zone, so that the drying procedure of the applied ink and print marks on the article is accelerated.

It is also advantageous that when the ink jet printer cartridges are empty, they can be exchanged so that the conveyed articles can be imprinted continuously.

The method is preferably developed further in that the print mark is applied by at least one ink jet printer cartridge from the office sphere.

It is furthermore advantageous if the ink jet printer cartridges are cleaned, in particular, before the machine is started up. Since the use of ink jet printer cartridges distinctly reduces the soiling anyway, the cleaning cycle creates a clean work environment around the printing mechanism and the article to be imprinted.

In order to monitor the position and quality of the print marks on the imprinted article, the print marks are detected by a sensor device. The sensor device is mounted, for example, at a point after which an imprinted cigarette paper wrapping strip is placed around a tobacco rod.

Further, the present invention provides a printing mechanism for applying print marks onto an article of the tobacco processing industry conveyed along a transport direction at a predetermined conveying speed, in particular, a wrapping strip, and preferably, a cigarette paper strip, that includes at least one ink jet printer cartridge is provided. Within the scope of the invention, it is equally conceivable to use a printing mechanism according to the invention in a packaging machine, in particular for articles of the tobacco processing industry.

In particular the at least one ink jet printer cartridge is arranged in a stationary manner.

To accelerate the printing process, several ink jet printer cartridges are provided for applying a print mark onto the conveyed article.

To this end in particular several ink jet printer cartridges are arranged in and/or transverse to the conveying direction of the article.

It is also favorable if the ink jet printer cartridges are arranged in cascade form.

Advantageously the ink jet printer cartridges can be controlled by a control device, in particular, a computer unit, so that the ink jet printer cartridges are freely programmable.

In order to achieve a secure imprint on the article, a drying zone is also provided for the print marks, so that a smearing of a print mark is reliably avoided by means of a rapid drying.

It is moreover favorable if the at least one ink jet printer cartridge is an ink jet printer cartridge from the office sphere. Thus, standardized and commercially available printer cartridges can be used in a printing mechanism, which results in a reduction in the costs for applying the print marks.

It is also preferred for the ink jet printer cartridges to be exchangeable and/or cleanable. In order to monitor the print image, a sensor device is provided for the print marks.

Furthermore, the instant invention utilizes at least one ink jet printer cartridge in a printing mechanism of a machine of the tobacco processing industry that is provided with a printing mechanism according to the invention and described above. In a further embodiment, it is possible to use an ink jet printer cartridge in a printing mechanism of a machine of the packaging industry. In a packaging machine likewise conveyed articles, for example, blanks, are provided with an imprint.

Moreover, the invention provides a machine of the tobacco processing industry, in particular, an endless rod maker or filter tipping machine that is provided with a printing mechanism according to the invention described above. The printing device according to the invention is preferably used on an endless rod maker for imprinting a wrapping strip.

The present invention is directed to a method for applying print marks on a tobacco processing industry article. The method includes conveying the tobacco processing industry article along a transport direction at a predetermined conveying speed, and applying the print mark to the tobacco processing industry article via at least one ink jet printer cartridge.

In accordance with a feature of the invention, the tobacco processing industry article can include a wrapping strip, and the wrapping strip can be a cigarette paper strip.

According to another feature of the invention, the at least one ink jet printer cartridge may include at least a part of a printing mechanism. Further, the printing mechanism can be part of a cigarette processing machine. The printing mechanism may be stationarily mounted.

Moreover, the at least one ink jet printer cartridge can be stationarily mounted.

The at least one ink jet printer cartridge can include a plurality of ink jet printer cartridges. The print mark can be applied by the plurality of ink jet printer cartridges. Further, the plurality of ink jet printer cartridges may be arranged at least one of in and transversely to the transport direction. The plurality of ink jet printer cartridges can be arranged in a cascade form.

The method can further include controlling the at least one ink jet printer cartridge via a control unit. The control unit can include a computer unit.

Still further, the method may include drying the print marks in a drying zone.

According to the present invention, the at least one ink jet printer cartridge can be a conventional office product.

The method may also include detecting the print marks with a sensor device.

In accordance with the instant invention, the print mark can be formed by a color ink, and the color ink can be a water-soluble ink.

Further, the method can include conveying the tobacco processing industry article over a planar path, such that the print mark can be applied to the tobacco processing industry article along the planar path.

The present invention is directed to a printing mechanism for applying print marks on a tobacco processing industry article conveyed along a transport direction at a predetermined conveying speed. The printing mechanism comprises a tobacco processing industry article conveyor and at least one ink jet printer cartridge. The tobacco processing industry article can be a wrapping strip, and the wrapping strip may be a cigarette paper strip.

According to a feature of the invention, the at least one ink jet printer cartridge can be stationarily mounted.

Further, the at least one ink jet printer cartridge may include a plurality of ink jet printer cartridges. The plurality of ink jet printer cartridges may be arranged at least one of in and transversely to the transport direction. Moreover, the plurality of ink jet printer cartridges can be arranged in a cascade form.

The printing mechanism can also include a control device. The ink jet printer cartridges may be controllable by the control device. The control device may be a computer unit.

The printing mechanism may also include a drying zone, arranged downstream from the at least one ink jet printing cartridge relative to the transport direction, structured and arranged to dry the print marks.

Further, the at least one ink jet printer cartridge can be a conventional is an ink jet printer cartridge of an office product.

The printing mechanism can include a sensor device arranged downstream from the at least one ink jet printing cartridge relative to the transport direction, structured and arranged to monitor the print marks.

Still further, the at least one ink jet printer cartridge contains color ink, and color ink is a water-soluble ink.

In accordance with still another feature of the instant invention, a conveyor may be structured and arranged to convey the tobacco processing industry article over a planar path, and the at least one ink jet printer cartridge can be structured and arranged to apply the print mark to the tobacco processing industry article along the planar path.

The present invention is directed to a method of printing a tobacco processing industry article in the above-noted printing mechanism. The method includes conveying the tobacco processing industry article along a transport direction at a predetermined conveying speed, and applying, with the at least one ink jet printer cartridge, a print mark to the tobacco processing industry article.

According to a feature of the invention, the method can further include conveying the tobacco processing industry article over a planar path, such that the print mark is applied to the tobacco processing industry article along the planar path.

The invention is directed to a machine of the tobacco processing industry that includes the above-noted printing mechanism.

In accordance with still yet another feature of the present invention, the machine can include a planar guide path for the tobacco processing industry article, and the at least one ink jet printer cartridge may be arranged to apply a print mark to the tobacco processing industry article along the planar guide path. Further, the machine can be an endless rod maker or the machine can be a filter tipping machine.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 illustrates an endless rod maker equipped with a printing device according to the invention;

FIG. 2 illustrates a perspective view of a printing mechanism according to the invention; and

FIG. 3 illustrates a diagrammatic representation of a printing mechanism according another embodiment of the invention.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

In the figures the same or similar elements or corresponding parts are respectively provided with the same reference numbers, so that a corresponding renewed introduction is unnecessary and only deviations of the exemplary embodiments shown in these figures from the first exemplary embodiment are explained.

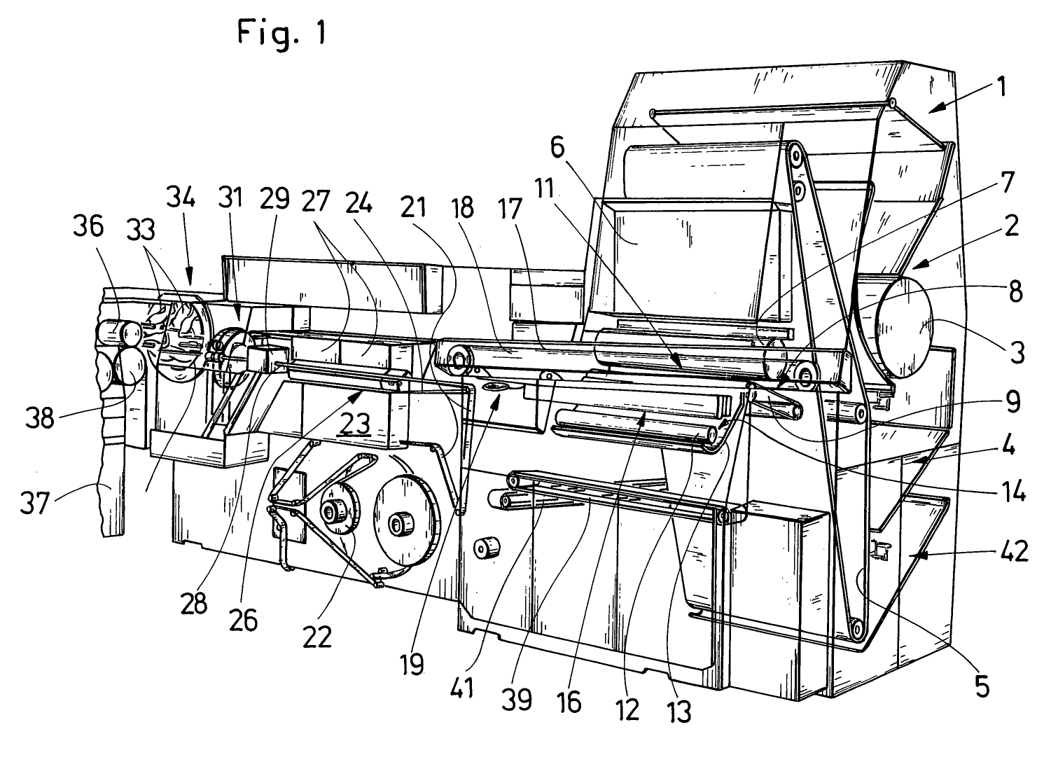

In the endless rod maker shown in FIG. 1, a pre-distributor 2 is charged with portions of tobacco from a gate 1. A removal roll 3 of pre-distributor 2 replenishes a supply container 4 with tobacco in a controlled manner, from which container a steep conveyor 5 removes tobacco and charges a retaining chute 6 in a controlled manner.

From retaining chute 6, a pin roll 7 removes a uniform stream of tobacco that is shaken out from the pins of pin roll 7 by a deflection roll 8 and is thrown onto a dispersion cloth 9 rotating at a constant speed. A fibrous web of tobacco formed on dispersion cloth 9 is thrown into a sifting device 11, which essentially comprises an air curtain through which larger or heavier tobacco pieces pass, while all other tobacco particles are guided by the air into a funnel 14 formed by a pin roll 12 and a wall 13.

The tobacco is thrown by pin roll 12 into a tobacco channel 16 towards a rod conveyor 17 on which the tobacco is held by air suctioned into a vacuum chamber 18, and a tobacco rod is combined.

A leveler 19 removes excess tobacco from the tobacco rod, which is then placed onto a parallely guided cigarette paper strip 21. Cigarette paper strip 21, which is drawn off from a bobbin 22, is guided through a printing device 23 and placed on a driven garniture belt 24. Garniture belt 24 transports the tobacco rod and cigarette paper strip 21 through a garniture 26 in which cigarette paper strip 21 is folded around the tobacco rod so that one edge still projects. This edge is then glued in a known manner by a gluing apparatus (not shown), and, thereafter, the adhesive seam is closed and dried by a tandem seam sealer 27.

An endless rod 28 formed in this manner is guided through a rod density gauge 29 that controls leveler 19, and is cut into double-length cigarettes 32 by a knife device 31. Double-length cigarettes 32 are transferred to a filter tipping machine 37 by a transfer device 34 formed by a takeover drum 36 featuring controlled arms 33 and a cutting drum 38 having a circular knife arranged to divide double-length cigarettes 32 into individual cigarettes.

Conveyor belts 39 and 41 convey excess tobacco into a container 42 arranged from the supply container 4, from which container 42 the returned tobacco is again removed by the steep conveyor 5.

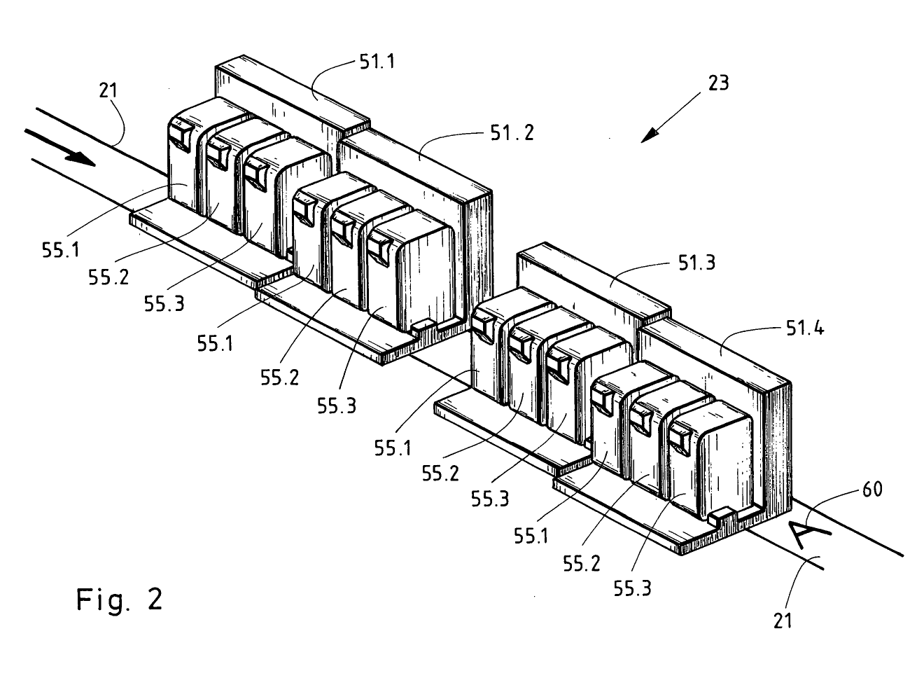

In FIG. 2 a printing mechanism according to the invention, which corresponds to printing mechanism 23 in FIG. 1, is diagrammatically shown in a perspective drawing. Printing mechanism 23 has four mountings 51.1-51.4, on which three ink jet printer cartridges 55.1-55.3 are respectively arranged one behind another. Within the scope of the invention, it is possible for each ink jet printer cartridge 55.1-55.3 to contain a colored ink respectively. According to the invention, ink jet printer cartridges 55.1-55.3 are commercially available and standardized printer cartridges for ink jet printers that can be used in the normal office sphere. Of course, it is equally possible for each printer cartridge 55.1-55.3 to be filled with the same color.

An optically dense imprint of a print mark 60 is achieved through the arrangement of printer cartridges 55.1-55.3 staggered behind one the other in the conveying direction of cigarette paper strip 21 to be imprinted. Due to the fact that ink jet printer cartridges 55.1-55.3 are arranged in a cascade manner on a mounting, for example, first printer cartridge 55.1 can produce a print image on cigarette paper strip 21, to which image ink is subsequently applied from one of the succeeding ink jet printer cartridges 55.2 or 55.3 to increase the density of the print image. This makes it possible to imprint cigarette paper strip 21, in such a manner that an imprint 60 at a high conveying speed of cigarette paper strip 21 is achieved. Because mountings 51.1-51.4 are arranged displaced with respect to one another transversely to the conveying direction of cigarette paper strip 21, it is guaranteed that the total width of cigarette paper strip 21 can be imprinted at a high speed.

Through printing mechanism 23 it is possible in particular to apply colored print marks 60 on cigarette paper strip 21. During a rapid garniture change on an endless rod maker, the ability to adapt the print mark rapidly to the different garnitures is achieved by a computer-assisted triggering of individual printer cartridges 55.1-55.3. In addition, as a result of the software control, it is possible to react to small optical changes, for example, of a trademark logo by a corresponding reprogramming.

Printing with printing mechanism 23 is carried out in an oil-free manner through the use of water-soluble colors as printing ink. Moreover, cleaning cycles of the print heads of ink jet printer cartridge 55.1-55.3 are easily carried out. The required cleaning cycles depend on the cleanness of the surroundings and the cigarette paper strips 21 to be imprinted.

The number of ink jet printer cartridges used for the printing depends on the width of the cigarette paper strip to be imprinted and on its conveying speed and they determine the resolution (print quality/dpi). At a printing width greater than the print head width of an ink jet printer cartridge, a further cascade set of ink jet printer cartridges is employed.

Through the printing mechanism according to the invention, the provision of cigarette paper and other papers of the tobacco processing industry with various print images and continuous markings flexibly and cleanly is achieved. Furthermore it is possible by the printing mechanism according to the invention to imprint in a multi-web manner, i.e., several material strips conveyed adjacent to one another. By these devices, for example, a double-web endless rod maker can be operated.

By using ink jet printer cartridges, the proven technology in the field of ink jet printers can be used for machines of the tobacco processing industry or packaging machines of the tobacco processing industry.

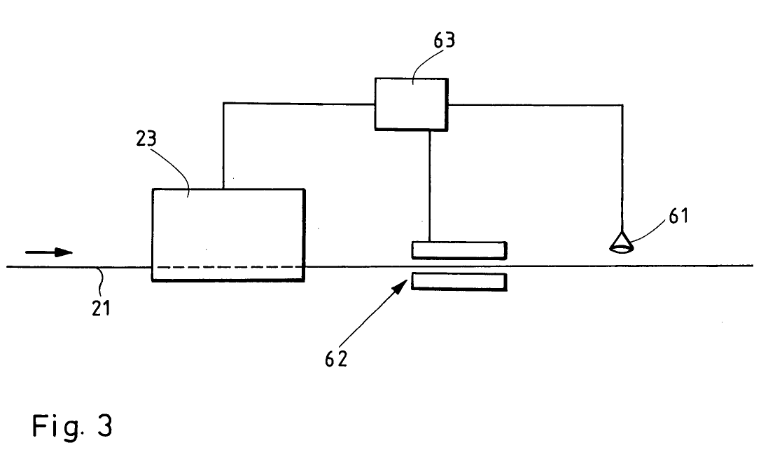

In FIG. 3, a further exemplary embodiment for a printing device or a printing mechanism according to the invention is shown in a diagrammatic representation. By printing mechanism 23 (see FIGS. 1 and 2), a print mark is applied on conveyed cigarette paper 21, so that subsequently a combined tobacco rod is wrapped with cigarette paper strip 21 (FIG. 1). In order to dry the ink applied to cigarette paper strip 21 more quickly, a drying zone 62 is provided after printing mechanism 23 in the conveying direction. Drying zone 62 is designed, e.g., as a heating region and is connected to a computer 63 that regulates the temperature of drying zone 62. Subsequently, cigarette paper strip 21 is guided past a sensor 61, by which the applied print marks are detected and monitored. To this end, sensor 61 is connected to computer 63. In order to implement a rapid adaptation and triggering of the ink jet printer cartridges in the printing mechanism 23, computer 63 is connected to the printing mechanism 23.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

### List of Reference Numbers

1 Gate
2 Pre-distributor
3 Removal roll
4 Supply container
5 Steep conveyor
6 Retaining chute
7 Pin roll
8 Deflection roll
9 Dispersion cloth
11 Sifting device
13 Belt
14 Funnel
16 Tobacco channel
17 Rod conveyor
18 Vacuum chamber
19 Leveler
21 Cigarette paper strip
22 Bobbin
23 Printing device
24 Garniture belt
26 Garniture
27 Tandem seam sealer
28 Endless rod
29 Rod density gauge
31 Knife device
32 Double-length cigarettes
33 Arms
34 Transfer device
36 Takeover drum
37 Filter tipping machine
38 Cutting drum
39 Conveyor belt
41 Conveyor belt
42 Container
51.1 to 51.4 Mounting
55.1 Ink jet printer cartridges
55.2 Ink jet printer cartridge
55.3 Ink jet printer cartridge
60 Print mark
61 Sensor
62 Drying zone
63 Computer

1. A method for applying print marks on a tobacco processing industry article, comprising:
conveying the tobacco processing industry article along a transport direction at a predetermined conveying speed;
applying the print mark to the tobacco processing industry article via at least one ink jet printer cartridge.

2. The method in accordance with claim 1, wherein the tobacco processing industry article comprises a wrapping strip.

3. The method in accordance with claim 2, wherein the wrapping strip comprises a cigarette paper strip.

4. The method in accordance with claim 1, wherein the at least one ink jet printer cartridge comprises at least a part of a printing mechanism.

5. The method in accordance with claim 4, wherein the printing mechanism is part of a cigarette processing machine.

6. The method in accordance with claim 4, wherein the printing mechanism is stationarily mounted.

7. The method in accordance with claim 1, wherein the at least one ink jet printer cartridge is stationarily mounted.

8. The method in accordance with claim 1, wherein the at least one ink jet printer cartridge comprises a plurality of ink jet printer cartridges.

9. The method in accordance with claim 8, wherein the print mark is applied by the plurality of ink jet printer cartridges.

10. The method in accordance with claim 8, wherein the plurality of ink jet printer cartridges are arranged at least one of in and transversely to the transport direction.

11. The method in accordance with claim 10, wherein the plurality of ink jet printer cartridges are arranged in a cascade form.

12. The method in accordance with claim 1, further comprising controlling the at least one ink jet printer cartridge via a control unit.

13. The method in accordance with claim 12, wherein the control unit comprises a computer unit.

14. The method in accordance with claim 1, further comprising drying the print marks in a drying zone.

15. The method in accordance with claim 1, wherein the at least one ink jet printer cartridge is a conventional office product.

16. The method in accordance with claim 1, further comprising detecting the print marks with a sensor device.

17. The method in accordance with claim 1, wherein the print mark is formed by a color ink.

18. The method in accordance with claim 17, wherein the color ink is a water-soluble ink.

19. The method in accordance with claim 1, further comprising:
conveying the tobacco processing industry article over a planar path, wherein the print mark is applied to the tobacco processing industry article along the planar path.

20. A printing mechanism for applying print marks on a tobacco processing industry article conveyed along a transport direction at a predetermined conveying speed, comprising:
a tobacco processing industry article conveyor; and
at least one ink jet printer cartridge.

21. The printing mechanism in accordance with claim 20, wherein said tobacco processing industry article comprises a wrapping strip.

22. The printing mechanism in accordance with claim 21, wherein said wrapping strip comprises a cigarette paper strip.

23. The printing mechanism in accordance with claim 20, wherein said at least one ink jet printer cartridge is stationarily mounted.

24. The printing mechanism in accordance with claim 20, wherein said at least one ink jet printer cartridge comprises a plurality of ink jet printer cartridges.

25. The printing mechanism in accordance with claim 24, wherein said plurality of ink jet printer cartridges are arranged at least one of in and transversely to the transport direction.

26. The printing mechanism in accordance with claim 24, wherein said plurality of ink jet printer cartridges are arranged in a cascade form.

27. The printing mechanism in accordance with claim 20, further comprising a control device, wherein said ink jet printer cartridges are controllable by said control device.

28. The printing mechanism in accordance with claim 27, wherein said control device comprises a computer unit.

29. The printing mechanism in accordance with claim 20, further comprising a drying zone, arranged downstream from said at least one ink jet printing cartridge relative to the transport direction, structured and arranged to dry the print marks.

30. The printing mechanism in accordance with claim 20, wherein said at least one ink jet printer cartridge comprises a conventional is an ink jet printer cartridge of an office product.

31. The printing mechanism in accordance with claim 20, further comprising a sensor device arranged downstream from said at least one ink jet printing cartridge relative to the transport direction, structured and arranged to monitor the print marks.

32. The printing mechanism in accordance with claim 20, wherein said at least one ink jet printer cartridge contains color ink.

33. The printing mechanism in accordance with claim 32, wherein said color ink is a water-soluble ink.

34. The printing mechanism in accordance with claim 20, further comprising:
a conveyor structured and arranged to convey the tobacco processing industry article over a planar path; and
said at least one ink jet printer cartridge is structured and arranged to apply the print mark to the tobacco processing industry article along the planar path.

35. A method of printing a tobacco processing industry article in the printing mechanism in accordance with claim 20, comprising:
conveying the tobacco processing industry article along a transport direction at a predetermined conveying speed; and
applying, with the at least one ink jet printer cartridge, a print mark to the tobacco processing industry article.

36. The method in accordance with claim 35, further comprising:
conveying the tobacco processing industry article over a planar path, wherein the print mark is applied to the tobacco processing industry article along the planar path.

37. A machine of the tobacco processing industry comprising the printing mechanism in accordance with claim 20.

38. The machine in accordance with claim 37, further comprising:
a planar guide path for the tobacco processing industry article; and
said at least one ink jet printer cartridge being arranged to apply a print mark to the tobacco processing industry article along the planar guide path.

39. The machine in accordance with claim 37, wherein said machine comprises an endless rod maker.

40. The machine in accordance with claim 37, wherein said machine comprises a filter tipping machine.
